(19) United States
(12) Patent Application Publication
(10) Pub. No.: US 2011/0037211 A1
(43) Pub. Date: Feb. 17, 2011

(54) Counter culture corner cutter (C4 corner cutter, for short)

(75) Inventor: David C. King, Lexington, SC (US)

Correspondence Address: David King, 226 Mossborough Dr., Lexington, SC, 29073, US

(73) Assignee: Susan Lynne King, Lexington, SC (US)

(21) Appl. No.: 12/658,249

(22) Filed: Feb. 5, 2010

Related U.S. Application Data
(60) Provisional application No. 61/207,129, filed on Feb. 9, 2009.

(51) Int. Cl. B23Q 3/00

(52) U.S. Cl. 269/289 R

(57) ABSTRACT

A board wargaming hobbyist's tool constructed of .22-.25″ thick plexiglass, consisting of two 1″×¾″ beveled flanges glued on a 1-½″ square base. Either a self-adhesive felt or high-density foam piece is affixed to the bottom to provide scratch protection and to add color to the piece (not part of functionality). When used with a hobby knife it allows up to 10 cardboard counters (square game pieces) to be stacked with ragged corners protruding through the bevels, so that they can be trimmed off quickly and consistently. This greatly decreases preparation time of game pieces.

The C4 Corner Cutter is a tool invented specifically for board wargaming hobbyists. The U.S. board wargaming hobby began in 1955 and still two things remain common to virtually all of the games: a mapsheet playing surface and cardboard counters (½″ to 1″ printed, die-cut squares). These pieces are punched or cut loose from cardboard frames, usually leaving ragged corners. Players trim these corners off, one counter at a time, in a process called “counter clipping,” because nail clippers are the primary tool used. Given that some games contain up to 3,000 counters, it is a long, tedious process.

The C4 Corner Cutter dramatically speeds up this process. Users can stack up to 10 counters in the C4 and cut them all at once using a common hobby knife, such as the X-acto. This means that the typical game of 400 to 500 counters can be prepped in under an hour, instead of the several hours required using nail clippers.

### Process of Making the C4 Corner Cutter

### Materials and Tools Needed

Plexiglasss, .22″ thickness

1-¾″ squares of Adhesive-back felt or high-density foam, various colors

Cyanoacrilate glue (super glue)

Pre-printed paper logo label

Table saw

Bench-top circular/belt sander

X-acto heavy-duty handle w/ no. 18 blade

Butane mini torch

Holding clamp

Square (machinists type)

Assembly jig (see below)

5/16″ plastic “L” strips

⅜″ square wood dowel

Sandpaper (150 grit)

File

### Production Steps

### Step 1: Cut Bases

Set table saw for 1.5″ width. Cut several strips of plexiglass. Reposition strips perpendicularly to blade and again cut to form 1.5″ squares.

### Step 2: Cut Side Pieces

Set table saw for 1″ width. Cut several strips of plexiglass. Set table saw for ¾″ width. Reposition strips perpendicularly to the saw blade and cut strips to form 1″×¾″ pieces.

### Step 3: Finish Sanding

Using a bench sander with circular and belt sanders, set table perpendicular to circular sander. Sand all four sides of base pieces, checking finished pieces to ensure squareness. Repeat the process for side pieces. Then adjust table to 45 degree angle and sand one ¾″ end of each side piece until the remaining flat tip is 1/16″. Using 150-grit sandpaper laid flat on workbench, sand off any remaining flashing or sharp edges.

### Step 4: Pairing Side Pieces

Due to kerf in cutting, sanding, etc., not all of the side pieces will be precisely the same size. Sort them into pairs of identical height.

### Step 5: Annealing

Using a holding clamp and butane mini torch set on medium flame, anneal all four edges of base pieces. For side pieces, anneal only one long edge (top) and the short edge opposite the bevel. Do not anneal beveled edge or one long edge. See Specification Drawings (Side Flanges, side elevations) to determine which are the top edges.

### Step 6: Assembly of Plexi Unit

Gather together the assembly jig (see below), super glue, 3″ machinists square, and file. With the beveled edge to the outside, stand two side pieces (flanges) on base with beveled edges facing the same corner. Use a 3″ machinists square to ensure each side piece stands at 90-degree vertical. Use file to hone bottom edge as needed.

Position the assembly jig at one corner of the base. Run a small bead of super glue along the un-annealed bottom edge of one flange, then position it on the base as shown in drawing; hold in place for 10 seconds. Repeat for the other side piece. Set aside for a minimum of 3 hours to allow complete drying and curing of the super glue.

### Step 7: Finishing

Gather together a square piece of adhesive-backed felt or high-density foam (according to choice of available colors), a pre-printed logo label, a microfiber or polishing cloth, a razor blade holder (scraper), and the plexi assembly from Step 6.

Use the cloth to clean all surfaces of the plexi unit. Peel the backing off the felt or foam piece and lay it on a flat surface, adhesive side up. Place a logo label in the center of the adhesive area with the “C4” facing one corner. Firmly press the bottom of the plexi unit onto the adhesive backing with the “C4” facing the opening between the bevels.

Use the razor blade to trim excess felt/foam from the unit so that it is flush with the edge of the plexi base. Using thumb and forefinger, press the material more firmly to the base. Wipe again with the polishing cloth.

The C4Corner Cutter is complete.

### Assembly Jig

To create the assembly jig cut a ⅜″ square wood dowel to a length of 1″ and cut a 5/16″ L-shaped plastic strip to a 1- 3/16″ length. Glue the plastic strip to the wood dowel so the plastic is flush with one end of the dowel. Let it dry. Draw or etch a thin black line perpendicular to the length of the dowel 3/32″ from the front corner (all wood corner), on both sides of the corner (this is a guideline against which the flanges are placed). Jig is complete. Note: this is an aid to assembly and not part of the invention itself, for which patent protection is claimed.

### How to Use the C4 Corner Cutter

A ¾″ long piece of 5/16″ L-shaped plastic strip is provided with the C4 Corner Cutter to assist in holding the counters, although it is not actually part of the C4, nor necessary for its use.

With the base of the C4 on a flat surface, such as a table, stack 6 to 10 untrimmed counters against the flanges with one corner of the stack protruding through the opening between the bevels. Hold them firmly in place with thumb and index finger (the L-shaped plastic piece can make this easier). Using an X-acto hobby knife (or similar) with heavy-duty handle and no. 18 blade (or similar), place the unhoned edge of the blade flat against the bevels at the top of the stack and and push straight down to cut the corners off the counters. Turn the stack and repeat for the other corners. This completes the process for one stack. (See accompanying Instruction Sheet, [“How to Use the C4”] which verifies the user's cutting process.)

### BRIEF DESCRIPTION OF DRAWINGS

Illustrative figures included on the Specification Drawings page are as follows:

FIG. 1: Unit Base
FIG. 1a: Top-down view of the base of the C4 Corner Cutter
FIG. 1b: Side elevation of the base of the C4 Corner Cutter

FIG. 2: Side Flanges
FIG. 2a: Side elevation of right flange of the C4 Corner Cutter
FIG. 2b: Side elevation of left flange of the C4 Corner Cutter
FIG. 2c: Top-down view of right flange of the C4 Corner Cutter
FIG. 2d: Top-down view of left flange of the C4 Corner Cutter

FIG. 3: Assembled Unit
FIG. 3a: Top-down view of fully assembled C4 Corner Cutter
FIG. 3b: Side elevation of fully assembled C4 Corner Cutter

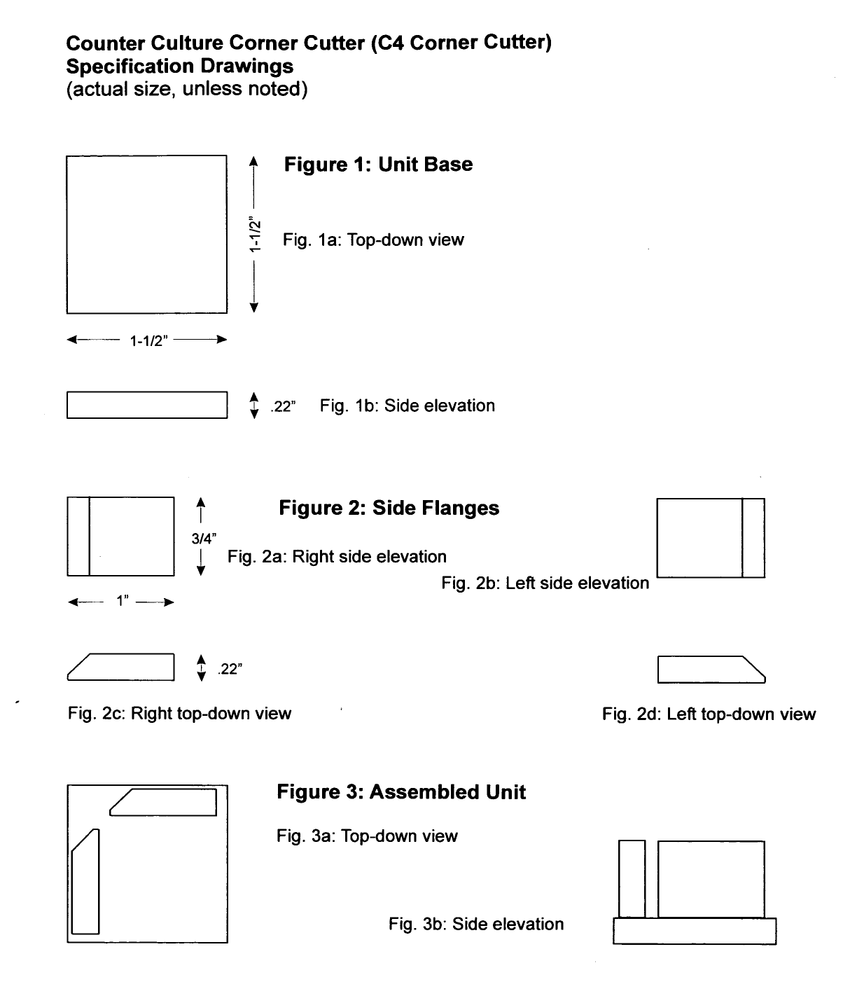

1. What I claim as my invention is the fully assembled C4 corner cutter unit: The C4 Corner Cutter is a unique item which significantly contributes to the board wargaming hobby and thus I seek patent protection.
